(19) United States
(12) Patent Application Publication
(10) Pub. No.: US 2014/0154420 A1
(43) Pub. Date: Jun. 5, 2014

(54) PARTIALLY FLUORINATED COPOLYMERS

(71) Applicant: E I DU PONT DE NEMOURS AND COMPANY, Wilmington, DE (US)

(72) Inventor: JOHN CHRISTOPHER SWOREN, Chadds Ford, PA (US)

(73) Assignee: E I DU PONT DE NEMOURS AND COMPANY, Wilmington, DE (US)

(21) Appl. No.: 14/071,718

(22) Filed: Nov. 5, 2013

Related U.S. Application Data
(60) Provisional application No. 61/733,603, filed on Dec. 5, 2012.

(51) Int. Cl. C09D 133/14

(52) U.S. Cl. CPC C09D 133/14
USPC 427/427.4; 524/544; 427/429; 427/430.1; 427/440; 427/428.01

(57) ABSTRACT

This invention is directed to a copolymer comprising fluorinated (met)acrylates, alkyl methacrylates, ethoxylates (meth)acrylates, and alkyl amino (meth)acrylates. These copolymers are capable of providing improved oil and water repellency to hard substrates while also maintaining its stability in a mixture of organic solvents.

### FIELD OF THE INVENTION

This invention relates to partially fluorinated copolymers having alkylamino groups, the manufacture thereof, and the methods of use thereof on hard surface substrates and leather to provide water and oil repellency, and stain resistance.

### BACKGROUND OF THE INVENTION

Most commercially available fluorinated acrylic co-polymers used as water/oil repellents or stain resist are produced through telomerization. These copolymers are generally applied in aqueous media and applied to the substrates. It has been found that these compounds have not been successful in offering high water/oil repellency and stain resistance while maintaining stability in high non-polar solvent systems.

In U.S. Patent Application No. 20110200829, Ober et al. describes a solvent-based copolymer containing a fluorinated monomer, a non-fluorinated monomer and a hydroxyalkyl monomer useful for leather and hard surface substrates.

While the compounds, such as those described in Ober et al., provide surface effects to substrates while in an non-aqueous solvent system, the need for an improved oil and water repellency and stain resistance still exists. Specifically, there is a need to provide improved performance for water and oil repellency and stain resistance while maintaining stability in one or more mixed organic solvent systems. The present invention meets this need.

### SUMMARY OF THE INVENTION

The invention relates to a partially fluorinated copolymer comprising the reaction product of monomers copolymerized in the following percentages by weight:

a) from about 45% to about 75% of one or more monomers of Formula (I):

R_{f}-L-Q-C(O)—CR¹═CH₂ (I);

b) from about 25% to about 30% of one or more monomers of Formula (II):

R_{H}-Q-C(O)—CR²═CH₂ (II);

c) from about 0.5% to about 15% of one or more monomers of Formula (III):

R—(OCH₂CH₂)ₙ—(OCH₂CH(CH₃))ₚQ-C(O)—CR³═CH₂ (III);

d) from about 0.1% to about 4% of one or more monomers of Formula (IV):

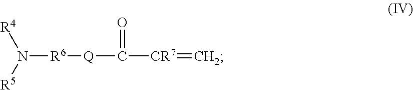

e) from about 0% to about 2% of one or more monomers of Formula (V):

HO—C(O)—CR⁸═CH2 (V);

f) from about from about 0% to about 2% of one or more monomers of Formula (VI):

HO—CH₂CH₂-Q-C(O)—CR⁹═CH₂ (VI);

g) from about from about 0% to about 2% of one or more monomers of Formula (VII):

CH₂═CR¹⁰C(O)O(CH₂CH₂O)ₓ(CH2CH(CH3)O)_{y}C(O)CR¹¹═CH₂ (VII);

wherein

R_{f} is a linear or branch fluoroalkyl of 2 to 10 carbons optionally interrupted by 1 to 4 interrupting groups —O—, —CH₂—, and/or —CHF— groups;

R_{H} is a linear, branched, or cyclic alkyl chain of 7 to 22 carbons;

each Q is independently —O— or —S—;

L is —R¹²—, —SO₂—N(R¹³)—R¹⁵—, —CO—N(R¹⁴)—R¹⁵—, —CH₂CH(OR¹⁴)CH₂—, —R⁶—SO₂—N(R¹⁴)—R¹⁵—, or —R¹⁵—O—C(O)—N(R¹⁴)—R¹⁵—;

R¹, R³, R⁷, R⁸, R⁹, R¹⁰, R¹¹ are each independently H or —CH₃;

R is —H or a linear, branched, or cyclic alkyl chain of 1 to 20 carbons;

R² is —CH₃;

R⁴ and R⁵ are each independently methyl or ethyl;

R⁶, R¹² and R¹⁵ are each independently a linear or branched divalent alkyl chain of 2 to 10 carbons;

R¹³ and R¹⁴ are each independently —H, —CH₃, C₂ to C₁₀ alkylene, or C₁ to C₄ acyl;

n is 0 to 10 and p is 0 to 10 provided that when p is 0, n is at least 2 and n+p is greater than 0; and

x is 0 to 10 and y is 0 to 10 provided that x+y is at least 1;

h) wherein the concentration of monomers of a), b), c), d), e), f), and g) is equal to 100% by weight. The monomers of Formula (III) and Formula (VII) in the present invention contain ethylene oxide (EO) and propylene oxide (PO) units in any order and are not limited to a block structure of co-monomers of EO and PO.

The present invention also relates to a method for treating a hard surface substrate comprises contacting the hard surface substrate with a fluorinated copolymer comprising of monomers a, b, c, d, e, f, and g.

### DETAILED DESCRIPTION

Herein trademarks are shown in upper case.

The term “(meth)acrylate” is used herein defined to mean both “acrylate” and “methacrylate”.

In the present invention, the concentration of the monomers a), b), c), d), e), f), and g) can be present at any concentration in the defined range. For example, the concentration of the repeating unit of monomer a) is present in a range of from 40% to 80% by weight of total monomers added means that the concentration of the of the repeating unit of fluorinated (meth)acrylate is present at 40%, 41%, 42%, . . . , 78%, 79%, or 80%. The concentration of monomer b) is present 10%, 11%, 12%, . . . , 33%, 34%, or 35%. The concentration of monomer c) is present in a range of from 5%, 6%, 7%, . . . , 23%, 24%, or 25%. The concentration of monomer d) is present at 0.5%, 0.6%, 0.7%, . . . , 13.5%, 14.0%, 14.5%, or 15%. The concentration of monomer d) is present at 0.5%, 0.6%, 0.7%, . . . , 13.5%, 14.0%, 14.5%, or 15%. The concentration of monomer e) is present at 0.5%, 0.6%, 0.7%, . . . , 13.5%, 14.0%, 14.5%, or 15%. The concentration of monomer f) is present at 0.5%, 0.6%, 0.7%, . . . , 13.5%, 14.0%, 14.5%, or 15%. The concentration of monomer g) is present at 0.5%, 0.6%, 0.7%, . . . , 13.5%, 14.0%, 14.5%, or 15%. The total concentration of each monomer is selected such that the total sum is equal to 100%.

The present invent relates to a partially fluorinated copolymer comprising the reaction product of monomers copolymerized in the following percentages by weight:

a) from about 45% to about 75% of one or more monomers of Formula (I):

R_{f}-L-Q-C(O)—CR¹═CH₂ (I);

b) from about 25% to about 30% of one or more monomers of Formula (II):

R_{H}-Q-C(O)—CR²═CH₂ (II);

c) from about 0.5% to about 15% of one or more monomers of Formula (III):

R—(OCH₂CH₂)ₙ—(OCH₂CH(CH₃))ₚQ-C(O)—CR³═CH₂ (III);

d) from about 0.1% to about 4% of one or more monomers of Formula (IV):

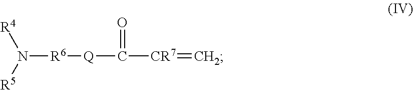

e) from about 0% to about 2% of one or more monomers of Formula (V):

HO—C(O)—CR⁸═CH2 (V);

f) from about from about 0% to about 2% of one or more monomers of Formula (VI):

HO—CH₂CH₂-Q-C(O)—CR⁹═CH₂ (VI);

g) from about from about 0% to about 2% of one or more monomers of Formula (VII):

CH₂═CR¹⁰C(O)O(CH₂CH₂O)ₓ(CH2CH(CH3)O)_{y}C(O)CR¹¹═CH₂ (VII);

wherein

R_{f} is a linear or branch fluoroalkyl of 2 to 10 carbons optionally interrupted by 1 to 4 interrupting groups —O—, —CH₂—, and/or —CHF— groups;

R_{H} is a linear, branched, or cyclic alkyl chain of 7 to 22 carbons;

each Q is independently —O— or —S—;

L is —R¹²—, —SO₂—N(R¹³)—R¹⁵—, —CO—N(R¹⁴)—R¹⁵—, —CH₂CH(OR¹⁴)CH₂—, —R⁶—SO₂—N(R¹⁴)—R¹⁵—, or —R¹⁵—O—C(O)—N(R¹⁴)—R¹⁵—;

R¹, R³, R⁷, R⁸, R⁹, R¹⁰, R¹¹ are each independently H or —CH₃;

R is —H or a linear, branched, or cyclic alkyl chain of 1 to 20 carbons;

R² is —CH₃;

R⁴ and R⁵ are each independently methyl or ethyl;

R⁶, R¹² and R¹⁵ are each independently a linear or branched divalent alkyl chain of 2 to 10 carbons;

R¹³ and R¹⁴ are each independently —H, —CH₃, C₂ to C₁₀ alkylene, or C₁ to C₄ acyl;

n is 0 to 10 and p is 0 to 10 provided that when p is 0, n is at least 2 and n+p is greater than 0; and

x is 0 to 10 and y is 0 to 10 provided that x+y is at least 1;
wherein the concentration of monomers of a), b), c), d), e), f), and g) is equal to 100% by weight.

The monomers of Formula (III) and Formula (VII) in the present invention contain ethylene oxide (EO) and propylene oxide (PO) units in any order and are not limited to a block structure of co-monomers of EO and PO.

The partially fluorinated copolymer of the present invention comprises repeat units from a) from about 45% to about 75% of one or more monomers of Formula (I):

R_{f}-L-Q-C(O)—CR¹═CH₂ (I)

wherein R_{f} is a linear or branch fluoroalkyl of 2 to 10 carbons optionally interrupted by 1 to 4 interrupting groups —O—, —CH₂—, and/or —CHF— groups; L is —R¹²—, —SO₂—N(R¹³)—R¹⁵—, —CO—N(R¹⁴)—R¹⁵—, —CH₂CH(OR¹⁴)CH₂—, —R⁶—SO₂—N(R¹⁴)—R¹⁵—, or —R¹⁵—O—C(O)—N(R¹⁴)—R¹⁵—; each Q is independently —O— or —S—; R¹ is —H or —CH₃; R⁶ is a linear or branched divalent alkyl chain of 2 to 10 carbons; R¹² and R¹⁵ are each independently a linear or branched divalent alkyl chain of 2 to 10 carbons; and R¹³ and R¹⁴ are each independently —H, —CH₃, C₂ to C₁₀ alkylene, or C₁ to C₄ acyl.

Examples of R_{f} include, but are not limited to, CF₃(CF₂)ₓ—, CF₃(CF₂)ₓ(CH₂CF₂)_{y}—, CF₃(CF₂)_{y}O(CF₂)_{y}—, and CF₃(CF₂)_{y}OCFH(CF₂)_{z}—, wherein each x is independently 1 to 9, each y is independently 1 to 3, and each z is independently 1 to 4. Preferably, R_{f} is C₂ to C₆ fluoroalkyl, more preferably, R_{f} is C₄ to C₆ fluoroalkyl, and most preferably, R_{f} is C₆ fluoroalkyl. Preferably, R¹ is —CH₃.

Fluorinated (meth)acrylates of Formula (I), are synthesized from the corresponding alcohols. These fluorinated (meth)acrylate compounds are prepared by either esterification of the corresponding alcohol with acrylic acid or methacrylic acid or by transesterification with methyl (meth)acrylate or methyl (meth)acrylate. These preparations are well known and are described in U.S. Pat. No. 3,282,905, herein incorporated by reference.

Fluorinated (meth)acrylates useful in the present invention are prepared from alcohols having the formula CF₃(CF₂)ₓ-L-OH wherein each x is individually 1 to 9; L is R¹² and R¹² is a linear or branched divalent alkyl chain of 2 to 10 carbons are commercially available from E. I. du Pont de Nemours and Company, Wilmington, Del. These alcohols are also be prepared by reaction of the corresponding perfluoroalkyl iodies with oleum and hydrolyzed according to the procedure described in WO 95/11877, herein incorporated by reference. These alcohols are available as a homologue distribution mixture or are fraction distilled into individual chain lengths.

Fluorinated (meth)(meth)acrylates useful in the present invention are prepared from alcohols having the formula CF₃(CF₂)ₓ(CH₂CF₂)_{y}-L-OH wherein each x is independently 1 to 4, each p is independently 1 to 2, and n is an integer from 1 to 10. These alcohols are prepared by the telomerization of perfluoroalkyl iodides with vinylidene fluoride followed by ethylene insertion. A detailed description of the vinylidene fluoride reaction is described in Balague, et al., “Synthesis of Fluorinated telomers, Part 1, Telomerization of vinylidene fluoride with perfluoroalkyl iodides”, J. Fluor. Chem. (1995), 70(2), 215-23. Reaction details for the ethylene insertion reaction are described in U.S. Pat. No. 3,979,469. The alcohols are prepared with oleum and hydrolysis as described above.

Fluorinated (meth)acrylates useful in the present invention are prepared from alcohols having the formula CF₃(CF₂)_{y}O(CF₂)_{y}-L-OH wherein each w is independently 1 to 3 and n is an integer of 1 to 10. These alcohols are prepared from the corresponding perfluoroalkyl ether iodides, of formula CF₃(CF₂)_{y}O(CF₂)_{y}I wherein each y is independently 1 to 3. These iodides are prepared according to the procedure described in U.S. Pat. No. 5,481,028, hereby incorporated by reference, by reacting a perfluorovinyl ether with ICI/HF and BF₃. Ethylene insertion and alcohol conversion is as described above.

The above fluorinated (meth)acrylate monomers are available either from Sigma-Aldrich (St. Louis, Mo.) or from E. I. du Pont de Nemours and Company (Wilmington, Del.).

The partially fluorinated copolymer of the present invention comprises repeat units from b) from about 25% to about 30% of one or more monomers of Formula (II):

R_{H}-Q-C(O)—CR²═CH₂ (II)

wherein R_{H} is a linear, branched, or cyclic alkyl chain of 7 to 22 carbons R² is —CH₃; and each Q is independently —O— or —S—.

Preferably, R_{H} is 7 to 20 carbons, more preferably 8 to 20 carbons. R_{H} is preferably octyl, 2-ethylhexyl, decyl, isodecyl, lauryl, cetyl, or stearyl. The preferred examples of comonomer b) are 2-ethylhexyl methacrylate, lauryl methacrylate and stearyl methacrylate.

The partially fluorinated copolymer of the present invention comprises repeat units from c) from about 0.5% to about 15% of one or more monomers of Formula (III):

R—(OCH₂CH₂)ₙ—(OCH₂CH(CH₃))ₚQ-C(O)—CR³═CH₂ (III);

wherein R is —H or a linear, branched, or cyclic alkyl chain of 1 to 20 carbons; n is 0 to 10 and p is 0 to 10 provided that when p is 0, n is at least 2 and n+p is greater than 0; Q is —O— or —S—; and R³ is —H or —CH₃. Both n and p are integers from 0 to 10 and include any number from 0, 0.1, 0.2, 0.3 . . . 9.8, 9.9, and 10. Compounds of Formula (III) may be a mixture of 2 or more compounds with n and p are defined as a number average of repeat units for the respective repeat units of ethylene oxide and propylene oxide. By “number average” it is meant that the average number listed, such as 3.5-EO/2.5-PO methacrylate, represents a mixture of compounds containing polyethylene oxide (EO) and/or polypropylene oxide (PO) repeat units where the average number of EO units equal 3.5 and the average number of PO units equal 2.5. The monomers of Formula (III) contain ethylene oxide (EO) and propylene oxide (PO) units in any order and are not limited to a block structure of co-monomers of EO and PO. In one preferred embodiment, p is 0. In another preferred embodiment, both p and n are greater than 0.

Examples of monomers of formula (III) include but not limited to 7-EO methacrylate, 9-PO methacrylate, and 3.5-EO/2.5-PO methacrylate. Monomers of formula (III) are commercially available from NOF Corporation, Shibuya-ku, Tokyo, Japan. Commercially available exampls include, but not limited to, BLEMMER E, BLEMMER P, BLEMMER PP-1000, BLEMMER 50PEP-300, BLEMMER 70PEP-350B, BLEMMER PAE-50, BLEMMER PAE-100, and BLEMMER 43APE-600B.

The partially fluorinated copolymer of the present invention comprises repeat units from d) from about 0.1% to about 4% of one or more monomers of Formula (IV):

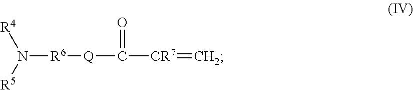

wherein R⁴ and R⁵ are each independently methyl or ethyl; R⁶ is a linear or branched divalent alkyl chain of 2 to 10 carbons; Q is —O— or —S—; and R⁷ is —H or —CH₃. Preferably compounds of compound (IV) are wherein R⁴ and R⁵ are each independently methyl or ethyl, and R⁶ is a linear divalent alkyl chain of 2 to 6 carbons. Examples of compounds of Formula (IV) include, but not limited to, dimethylaminoethyl (meth)acrylate, diethylaminoethyl (meth)acrylate, dimethylaminopropyl (meth)acrylate, and diethylaminopropyl (meth)acrylate.

The partially fluorinated copolymer of the present invention comprises repeat units from e) from about 0% to about 2% of one or more monomers of Formula (V):

HO—C(O)—CR⁸═CH2 (V)

wherein R⁸ is —H or —CH₃.

Compounds of formula (V) include methacrylic acid and acrylic acid.

The partially fluorinated copolymer of the present invention comprises repeat units from f) from about from about 0% to about 2% of one or more monomers of Formula (VI):

HO—CH₂CH₂-Q-C(O)—CR⁹═CH₂ (VI)

wherein Q is independently —O— or —S—; and R⁹ is H or —CH₃.

Examples of compounds of formula (VI) include hydroxyethyl (meth)acrylate.

The partially fluorinated copolymer of the present invention comprises repeat units from g) from about 0% to about 2% of one or more monomers of Formula (VII):

CH₂═CR¹⁰C(O)O(CH₂CH₂O)ₓ(CH2CH(CH3)O)_{y}C(O)CR¹¹═CH₂ (VII);

wherein R¹⁰ and R¹¹ are each independently H or —CH₃, x is 0 to 10, y is 0 to 10, provided that x+y is at least 1. The monomers of Formula (VII) in the present invention contain ethylene oxide (EO) and propylene oxide (PO) units in any order and are not limited to a block structure of co-monomers of EO and PO. Examples of compounds of Formula (VII) include poly(ethylene) glycol di(meth)acrylate and poly(propylene) glycol di(meth)acrylate.

The partially fluorinated copolymers of the present invention are prepared in organic solvent by free radical initiated polymerization of the monomers as defined above. The final product is a copolymer with a random distribution of the monomers as defined above. The partially fluorinated polymers in this invention are made by agitating the various monomers described above in organic solvent in a suitable reaction vessel which is equipped with an agitation device and an external heating and cooling device. A free radical initiator is added and the temperature raised to from about 20° to about 70° C. The polymerization initiator is exemplified by 2,2′-azobis(2-methylbutanenitrile). These initiators are sold by E. I. du Pont de Nemours and Company, Wilmington, Del., commercially under the name of “VAZO”. An example of a suitable polymerization regulator or chain transfer agent is dodecylmercaptan. Suitable organic solvents useful in the preparation of the polymers in the present invention include tetrahydrofuran, acetone, methyl isobutyl ketone, isopropanol, ethyl acetate, butyl acetate, and mixtures thereof. Butyl acetate is preferred. The reaction is conducted under an inert gas, such as nitrogen, to the exclusion of oxygen. The partially fluorinated copolymers can be isolated by precipitation, and are optionally purified by, for example, recrystallization. After polymerization, the concentration of the resulting partially fluorinated copolymers are generally diluted to about 35% by weight solids in butyl acetate. Treatment of hard surfaces typically require further dilution to about 2% by weight with either butyl acetate or a paraffin, such as mineral spirits. The about 2% by weight composition of the partially fluorinated copolymers can then be applied to substrates to improve surface properties of the substrates, such as increased stain resistance.

The partially fluorinated copolymers of the present invention can be produced with the various monomers present as defined above and the final copolymers depend on the monomers added during the polymerization process. In one embodiment, the partially fluorinated copolymer of the present invention may comprise the reaction product of a) fluorinated (meth)acrylates of Formula (I), b) alkyl methacryaltes of Formula (II), c) poly-ethylene/propylene (meth)acrylates of Formula (III), and d) dialkylamino (meth)acrylates of Formula (IV). In another embodiment the partially fluorinated copolymer of the present invention may comprise the reaction product of a) fluorinated (meth)acrylates of Formula (I), b) alkyl methacryaltes of Formula (II), c) poly-ethylene/propylene (meth)acrylates of Formula (III), d) dialkylamino (meth)acrylates of Formula (IV); and e) (meth)acrylic acid of Formula (V). In another embodiment the partially fluorinated copolymer of the present invention may comprise the reaction product of a) fluorinated (meth)acrylates of Formula (I), b) alkyl methacryaltes of Formula (II), c) poly-ethylene/propylene (meth)acrylates of Formula (III), d) dialkylamino (meth)acrylates of Formula (IV); e) (meth)acrylic acid of Formula (V); and f) hydroxyethyl (meth)acrylate of Formula (VI). In another embodiment the partially fluorinated copolymer of the present invention may comprise the reaction product of a) fluorinated (meth)acrylates of Formula (I), b) alkyl methacryaltes of Formula (II), c) poly-ethylene/propylene (meth)acrylates of Formula (III), d) dialkylamino (meth)acrylates of Formula (IV); e) (meth)acrylic acid of Formula (V); f) hydroxyethyl (meth)acrylate of Formula (VI), and g) poly-ethylene/propylene glycol di(meth)acrylates of Formula (VII). In another embodiment the partially fluorinated copolymer of the present invention may comprise the reaction product of a) fluorinated (meth)acrylates of Formula (I), b) alkyl methacryaltes of Formula (II), c) poly-ethylene/propylene (meth)acrylates of Formula (III), d) dialkylamino (meth)acrylates of Formula (IV); and f) hydroxyethyl (meth)acrylate of Formula (VI). In another embodiment the partially fluorinated copolymer of the present invention may comprise the reaction product of a) fluorinated (meth)acrylates of Formula (I), b) alkyl methacryaltes of Formula (II), c) poly-ethylene/propylene (meth)acrylates of Formula (III), d) dialkylamino (meth)acrylates of Formula (IV); f) hydroxyethyl (meth)acrylate of Formula (VI), and g) poly-ethylene/propylene glycol di(meth)acrylates of Formula (VII). In another embodiment the partially fluorinated copolymer of the present invention may comprise the reaction product of a) fluorinated (meth)acrylates of Formula (I), b) alkyl methacryaltes of Formula (II), c) poly-ethylene/propylene (meth)acrylates of Formula (III), d) dialkylamino (meth)acrylates of Formula (IV); and g) poly-ethylene/propylene glycol di(meth)acrylates of Formula (VII).

The copolymers of the present invention are stable in organic solvents. It has been found that these polymers, specifically containing the monomer d), are not only stable in organic solvents, but are also stable in mixed organic solvents. This is a critical characteristic of the present invention as it has been found that some end users prefer to use a mix of solvents when applying the copolymers to substrates to provide repellency such as, for example, butyl acetate and mineral spirits.

The present invention further provides a method for treating a hard surface substrate comprising contacting the hard surface substrate with a partially fluorinated copolymer comprising the reaction product of monomers copolymerized in the following percentages by weight:

a) from about 45% to about 75% of one or more monomers of Formula (I):

R_{f}-L-Q-C(O)—CR¹═CH₂ (I);

b) from about 25% to about 30% of one or more monomers of Formula (II):

R_{H}-Q-C(O)—CR²═CH₂ (II);

c) from about 0.5% to about 15% of one or more monomers of Formula (III):

R—(OCH₂CH₂)ₙ—(OCH₂CH(CH₃))ₚQ-C(O)—CR³═CH₂ (III);

d) from about 0.1% to about 4% of one or more monomers of Formula (IV):

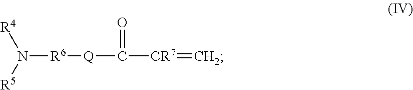

e) from about 0% to about 2% of one or more monomers of Formula (V):

HO—C(O)—CR⁸═CH2 (V);

f) from about from about 0% to about 2% of one or more monomers of Formula (VI):

HO—CH₂CH₂-Q-C(O)—CR⁹═CH₂ (VI);

g) from about from about 0% to about 2% of one or more monomers of Formula (VII):

CH₂═CR¹⁰C(O)O(CH₂CH₂O)ₓ(CH2CH(CH3)O)_{y}C(O)CR¹¹═CH₂ (VII);

wherein

R_{f} is a linear or branch fluoroalkyl of 2 to 10 carbons optionally interrupted by 1 to 4 interrupting groups —O−, —CH₂—, and/or —CHF— groups;

R_{H} is a linear, branched, or cyclic alkyl chain of 7 to 22 carbons;

each Q is independently —O— or —S—;

L is —R¹²—, —SO₂—N(R¹³)—R¹⁵—, —CO—N(R¹⁴)—R¹⁵—, —CH₂CH(OR¹⁴)CH₂—, —R⁶—SO₂—N(R¹⁴)—R¹⁵—, or —R¹⁵—O—C(O)—N(R¹⁴)—R¹⁵—;

R¹, R³, R⁷, R⁸, R⁹, R¹⁰, R¹¹ are each independently H or —CH₃;

R is —H or a linear, branched, or cyclic alkyl chain of 1 to 20 carbons;

R² is —CH₃;

R⁴ and R⁵ are each independently methyl or ethyl;

R⁶, R¹² and R¹⁵ are each independently a linear or branched divalent alkyl chain of 2 to 10 carbons;

R¹³ and R¹⁴ are each independently —H, —CH₃, C₂ to C₁₀ alkylene, or C₁ to C₄ acyl;

n is 0 to 10 and p is 0 to 10 provided that when p is 0, n is at least 2

and n+p is greater than 0; and

x is 0 to 10 and y is 0 to 10 provided that x+y is at least 1;

wherein the concentration of monomers of a), b), c), d), e), f), and g) is equal to 100% by weight.

The term “hard surface”, as used herein, includes porous surfaces, such as stone, masonry, concrete, unglazed tile, brick, porous clay and various other substrates with surface porosity. Specific examples of such substrates include unglazed concrete, brick, tile, stone (including granite, limestone and marble), grout, mortar, statuary, monuments, wood, composite materials such as terrazzo, and wall and ceiling panels including those fabricated with gypsum board. These are used in the construction of buildings, roads, parking ramps, driveways, floorings, fireplaces, fireplace hearths, counter tops, and other decorative uses in interior and exterior applications.

The method of the present invention of treating a hard surface to provide water and oil repellency to the substrate comprises application of the composition described above to the substrate. The composition is applied to the substrate by contacting the composition with the substrate using conventional means, including but not limited to, spray, brush, roller, doctor blade, wipe, and dip techniques, preferably using a first coating, optionally followed by one additional coat using a wet-on-wet technique. More porous substrates may require subsequent additional coats. The wet-on-wet procedure comprises applying a first coat which is allowed to soak into the substrate but not dry (e.g., for about 10-30 minutes) and then applying a second coat. Any subsequent coats are applied using the same technique as described for the second coat. The substrate surface is then allowed to dry under ambient conditions, or the drying can be accelerated by warm air if desired. The wet-on-wet application procedure provides a means to distribute or build up more of the protective coating at the substrate surface. Spray and wet-on-wet applications are preferred. And spray application is most preferred.

The present invention further comprises substrates treated according to the method of the present invention. These substrates comprise porous surfaced materials used in interior and exterior construction applications. A wide variety of construction substrates are suitable for use herein. Examples of such materials include unglazed concrete, brick, tile, stone (including granite and limestone), grout, mortar, composite materials such as terrazzo, wall and ceiling panels including those fabricated with gypsum board, marble, statuary, monuments, and wood. The treated substrates have desired stain resistance properties.

Substrates treatable in the present invention vary widely in their porosity including less porous materials, such as granite or marble, and more porous materials, such as limestone or Saltillo. The present invention is especially suitable for providing desired stain resistance to more porous substrates such as limestone or Saltillo. Thus limestone and Saltillo were tested in the Examples herein. A treatment that works well to provide stain resistance to more porous substrates will also work very well for less porous substrates, although the reverse is not true. The present invention provides stain resistance to more porous substrates while not altering their surface appearance.

The present invention also provides a method for treating a leather substrate comprising contacting the leather substrate with a with a partially fluorinated copolymer comprising the reaction product of monomers copolymerized in the following percentages by weight:

a) from about 45% to about 75% of one or more monomers of Formula (I):

R_{f}-L-Q-C(O)—CR¹═CH₂ (I);

b) from about 25% to about 30% of one or more monomers of Formula (II):

R_{H}-Q-C(O)—CR²═CH₂ (II);

c) from about 0.5% to about 15% of one or more monomers of Formula (III):

R—(OCH₂CH₂)ₙ—(OCH₂CH(CH₃))ₚQ-C(O)—CR³═CH₂ (III);

d) from about 0.1% to about 4% of one or more monomers of Formula (IV):

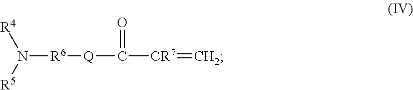

e) from about 0% to about 2% of one or more monomers of Formula (V):

HO—C(O)—CR⁸═CH₂ (V);

f) from about from about 0% to about 2% of one or more monomers of Formula (VI):

HO—CH₂CH₂-Q-C(O)—CR⁹═CH₂ (VI);

g) from about from about 0% to about 2% of one or more monomers of Formula (VII):

CH₂═CR¹⁰C(O)O(CH₂CH₂O)ₓ(CH2CH(CH3)O)_{y}C(O)CR¹¹═CH₂ (VII);

wherein

R_{f} is a linear or branch fluoroalkyl of 2 to 10 carbons optionally interrupted by 1 to 4 interrupting groups —O—, —CH₂—, and/or —CHF— groups;

R_{H} is a linear, branched, or cyclic alkyl chain of 7 to 22 carbons;

each Q is independently —O— or —S—;

L is —R¹²—, —SO₂—N(R¹³)—R¹⁵—, —CO—N(R¹⁴)—R¹⁵—, —CH₂CH(OR¹⁴)CH₂—, —R⁶—SO₂—N(R¹⁴)—R¹⁵—, or —R¹⁵—O—C(O)—N(R¹⁴)—R¹⁵—;

R¹, R³, R⁷, R⁸, R⁹, R¹⁰, R¹¹ are each independently H or —CH₃;

R is —H or a linear, branched, or cyclic alkyl chain of 1 to 20 carbons;

R² is —CH₃;

R⁴ and R⁵ are each independently methyl or ethyl;

R⁶, R¹² and R¹⁵ are each independently a linear or branched divalent alkyl chain of 2 to 10 carbons;

R¹³ and R¹⁴ are each independently —H, —CH₃, C₂ to C₁₀ alkylene, or C₁ to C₄ acyl;

n is 0 to 10 and p is 0 to 10 provided that when p is 0, n is at least 2

and n+p is greater than 0; and

x is 0 to 10 and y is 0 to 10 provided that x+y is at least 1;

wherein the concentration of monomers of a), b), c), d), e), f), and g) is equal to 100% by weight.

The leather substrate is based on hides that are natural products and therefore a variable substrate. For example, the leather substrate subjected to the treatment in the above method can be pretreated hides, i.e., with hides that had been cured, freed of flesh and excess hair, and treated by chrome tanning or an equivalent process. Such tanned hides are referred to in the industry as pelts or wet blue hides, and the term “wet blue hide stage” is used herein to describe this stage in the overall tanning process. The wet blue hides were washed and rinsed in lukewarm water to remove chemicals with which the hides had previously been treated. The next steps were buffering and character-building steps that equalized the pH of the leather and built desired characteristics such as suppleness into the hides. Retanning of the hides was continued by treating them with additional character builders to enhance and impart additional desirable characteristics.

In the method of the present invention, the process of contacting the leather substrate with the partially fluorinated copolymer as defined above can be carried out by any suitable methods. Such methods are known to those skilled in the art, and include for example, application by spray, dipping, foam, nip, immersion, brush, roller, sponge, mat, and similar conventional techniques. Application by spray, dipping and brush techniques are preferred. The leather substrate is based on hides that are natural products and therefore a variable substrate. Methods to adjust bath conditions and concentration to accommodate such natural variations are well known to those skilled in the art.

The present invention further comprises the leather substrates treated according to the above method of the present invention.

### Examples

### Test Method 1

### Determination of Stain Resistance

Limestone (Walker Zanger Alhambra Limestone) tiles, marble tiles and Saltillo tiles were treated and tested for stain resistance. The tiles were first rinsed under tap water and wiped dry. The tiles were then placed in a fan forced oven with a temperature setting of 60° C. for 2 hours. The tiles were removed and allowed to cool for a minimum of 15 minutes.

Treating solutions are made by diluting the compositions of the following examples from 35 weight % in butyl acetate to 2 weight % in mineral spirits. The compositions were then individually applied to separate tiles using a 1″ polyester bristle paint brush and allowed to dry for ten minutes before removing any excess liquid with the same brush. The treated tiles were placed into the oven at 60° C. for 60 minutes. The tiles were remove from the oven and allowed to cool for a minimum of 15 minutes. After cooling, the stain test analysis was performed. If applicable; the treated tile samples are allowed to sit for an additional 30 minutes before applying a subsequent coat. The process is repeated until the number of desired coats has been applied. Typically, two coats of product are applied to the substrate. The number of coats applied depends on the porosity of the substrate.

The following food stains were placed at intervals on the surface of the treated and dried limestone and Saltillo tiles and allowed to remain on the tile for 24 hours: 1) coke, 2) mustard, 3) bacon grease, 4) motor oil, 5) black coffee, 6) lemon juice, 7) grape juice, 8) ketchup, 9) Italian salad dressing, 10) canola oil.

After a 24-hour period, the food stains were blotted or lightly scraped from the tile surface. The tile's surface was rinsed with water and a stiff nylon bristle brush was used to scrub the surface to remove any remaining dried food residue. The tiles were then rinsed with water and allowed to dry for at least 24 hours before rating.

The stains remaining on the tile surfaces after cleaning were rated visually according to a scale of 0 to 4 as follows: 0=no stain; 1=very light stain; 2=light stain; 3=moderate stain; and 4=heavy stain. The ratings for each substrate type are summed for each of the stains to give a composite rating for each substrate. The maximum total score for each substrate was 10 stains times the maximum score of 4 per stain=40. Thus, the maximum composite score for both substrates (limestone and Saltillo) was two times the maximum score per substrate (40)=80. Lower scores indicate better stain protection with scores of 30 or less being acceptable and with zero indicating the best protection with no stain present.

### Test Method 2

### Water and Oil Beading

The copolymers of the present invention were applied to Limestone tiles, marble tiles and Saltillo tiles and were tested for water and oil beading. Three drops of DI water was placed on each treated tile. After five minutes, the contact angles were measured and given a rating as defined below. The larger the contact, the better the performance in water beading.

TABLE 1
Contact angle ratings

| Contact angle | Rating |
|---|---|
| 100-120° | 5 |
| 75-90° | 4 |
| 45-75° | 3 |
| 25-45° | 2 |
| 10-25° | 1 |
| <10° | 0 |

Oil bead testing was also performed on the treated tiles. Three drops of vegetable oil was placed on each treated tile. After five minutes, the contact angles were measured and given a rating as defined above. The larger the contact, the better the performance in oil beading.

### Test Method 3

### Water and Oil Kit Test

The Saltillo tiles and leather samples were treated with the copolymers of the present invention and tested for water and oil kit values. The water and oil kit test is a visual assessment of the drop penetration into the treated substrates. A drop of Test Solution #1 of each test solutions (water in Table 2 and oil in Table 3) were placed on the treated substrate. After 30 seconds, the drop was wiped off the surface and the test location was observed for penetration. Penetration was defined as a visual assessment of change in color of the tile. If no penetration occurred, Test Solution #2 was tested as in #1. The test is repeated until penetration occurs. The rating is the Test Solution when penetration occurred. The higher test solutions indicate better performance.

TABLE 2
Water Test Kit
Water Kit

| Test | DI Water | Isopropanol | Surface Tension |
|---|---|---|---|
| Solution # | (% Vol.) | (% Vol.) | (mN/m) |
| 1 | 98 | 2 | 59.0 |
| 2 | 95 | 5 | 49.8 |
| 3 | 90 | 10 | 41.6 |
| 4 | 80 | 20 | 32.5 |
| 5 | 70 | 30 | 27.4 |
| 6 | 60 | 40 | 25.4 |
| 7 | 50 | 50 | 24.5 |
| 8 | 40 | 60 | 24.0 |
| 9 | 30 | 70 | 23.4 |
| 10 | 20 | 80 | 22.7 |
| 11 | 10 | 90 | 21.9 |
| 12 | 0 | 100 | 21.8 |

TABLE 3
Oil Test Kit
Oil Kit

| Test Solution | | Surface Tension |
|---|---|---|
| # | Description | (mN/m) |
| 1 | 100% mineral Oil | 31.5 |
| 2 | 65% mineral Oil/ | 29.2 |
| | 35% n-Hexadecane | |
| 3 | n-Hexadecane | 27.3 |
| 4 | n-Tetradecane | 26.2 |
| 5 | n-Dodecane | 24.2 |
| 6 | n-Decane | 23.6 |
| 7 | n-Octane | 21.8 |
| 8 | n-Heptane | 19.7 |

### EXAMPLES

### Example 1

A reactor was equipped with a water cooled condenser, thermocouple, overhead stirrer, and nitrogen sparge. Butyl acetate and the following monomers of stearyl acrylate (SA) (24.69 g), ethylhexyl methacrylate (EHMA) (0.45 g), 2-hydroxyethyl methacrylate (HEMA) (0.93 g), 7-EO methacrylate (7EOMA) (9.04 g), CF₃(CF₂)₅CH₂CH₂OC(O)C(CH₃)CH₂ (R_{f}MA) (62.77 g, available from E. I. du Pont de Nemours and Company, Wilmington, Del.), 2-(diethylamino)ethyl methacrylate (DEAM) (1.23 g) and VAZO 67 (0.0.89 g in butyl acetate, available from E. I. du Pont de Nemours and Company, Wilmington, Del.) were charged to the reactor. Reactor was heated to 50° C. with a sub-surface nitrogen sparged for 30 minutes and the agitator was set to 200 rpm. After 30 min sparge was switched to blanket. Temperature was raised to and held at 80° C.

The reactor was then cooled to ambient room temperature. Additional butyl acetate was added to the reactor and the mixture stirred for 30 min to provide a 35% solids mixture. The above product was then tested for stain resistance according to Method 1 and for stability according to Test Method 2.

### Examples 2 to 3

Examples 2 and 3 are repeats of Example 1 with different concentrations of the monomers as listed in Table 4.

TABLE 4
Monomer concentration for Examples 2 and 3

| Monomers | Example 2 | Example 3 |
|---|---|---|
| R_{f}MA (g) | 62.8 | 62.3 |
| EHMA (g) | 0.45 | 0.44 |
| SMA (g) | 24.7 | 24.4 |
| 7-EOMA (g) | 9.03 | 8.95 |
| HEMA (g) | 0.93 | 0.92 |
| DEAM (g) | 1.23 | 1.22 |

The above copolymers were then tested for stain resistance according to Method 1 for Saltillo only and for stability according to Test Method 2.

### Examples 4 to 6

Examples 4 to 6 were repeats of Example 1 and include an additional dialkylaminoalkyl containing monomer, (dimethylamino)ethyl methacrylate (DMAM). The concentrations of each monomers are listed in Table 5.

TABLE 5
Monomer concentration for Examples 4 to 6

| Monomers | Example 4 | Example 5 | Example 6 |
|---|---|---|---|
| RfMA (g) | 62.3 | 62.3 | 62.3 |
| EHMA (g) | 0.19 | 0.19 | 0.19 |
| SMA (g) | 21.5 | 21.5 | 21.5 |
| 7-EOMA (g) | 10.1 | 10.1 | 10.2 |
| HEMA (g) | 1.73 | 1.73 | 1.69 |
| DEAM (g) | 1.71 | 1.74 | 1.71 |
| DMAM (g) | 1.75 | 1.7 | 1.75 |

### Example 7

Example 7 was prepared similar to Example 1, including additional monomers DMAM and ethyl glycol dimethacrylate (EGMA). The concentrations of each monomers are listed in Table 6.

TABLE 6
Monomer concentration for Example 7

| Monomers | Example 7 |
|---|---|
| RfMA (g) | 62 |
| EHMA (g) | 0.18 |
| SMA (g) | 21.4 |
| 7-EOMA (g) | 10 |
| HEMA (g) | 1.71 |
| DEAM (g) | 1.7 |
| DMAM (g) | 1.7 |
| EGMA (g) | 0.68 |

### Example 8

Example 8 was prepared similar to Example 4, except (dimethyl)ethyl amino methacrylate (DMAM) was used in place of (diethylamino) ethyl methacrylate (DEAM). The concentrations of each monomers are listed in Table 7.

TABLE 7
Monomer concentration for Example 8

| Monomers | Example 8 |
|---|---|
| RfMA (g) | 62.79 |
| EHMA (g) | 0.46 |
| SMA (g) | 24.71 |
| 7-EOMA (g) | 9 |
| HEMA (g) | 0.92 |
| DMAM (g) | 1.24 |

### Examples 9 to 14

Examples 9 to 14 were prepared similar to Example 1 and included additional monomers methacrylic acid (MAA) and dodecyl mercapton (DDM) as a chain transfer agent. The concentrations of each monomers are listed in Table 8.

TABLE 8
Monomer concentration for Examples 9 to 14

| Monomers | Ex. 9 | Ex. 10 | Ex. 11 | Ex. 12 | Ex. 13 | Ex. 14 |
|---|---|---|---|---|---|---|
| RfMA (g) | 62.42 | 61.47 | 61.32 | 60.91 | 60.8 | 61 |
| EHMA (g) | 0.45 | 0.88 | 0.91 | 0.87 | 0.87 | 0.91 |
| SMA (g) | 24.56 | 30.82 | 24.14 | 30.46 | 23.89 | 23.98 |
| 7-EOMA | 8.9 | 2.26 | 8.89 | 2.18 | 0.87 | 8.7 |
| (g) | | | | | | |
| HEMA (g) | 0.9 | 1.36 | 1.53 | 1.31 | 1.52 | 1.54 |
| DEAM (g) | 0.39 | 1.48 | 1.47 | 1.51 | 1.46 | 1.48 |
| MAA (g) | 1.49 | 0.37 | 0.38 | 1.46 | 1.46 | 1.47 |
| DDM (g) | 0 | 0.48 | 0.48 | 0.44 | 0.44 | 0.052 |

### Example 15

Example 15 was prepared similar to Example 10 but was polymerized without HEMA but included dodecyl mercapton (DDM) as a chain transfer agent. The concentrations of each monomers are listed in Table 9.

### Example 16

Example 16 was prepared similar to Example 9 but was polymerized without HEMA. The concentrations of each monomers are listed in Table 9.

TABLE 9
Monomer concentration for Examples 15 and 16

| Monomers | Example 15 | Example 16 |
|---|---|---|
| RfMA (g) | 61.94 | 62.93 |
| EHMA (g) | 0.91 | 0.46 |
| SMA (g) | 24.34 | 24.76 |
| 7-EOMA (g) | 8.88 | 9.06 |
| DEAM (g) | 1.49 | 0.39 |
| MAA (g) | 1.5 | 1.51 |
| DDM | 0.048 | — |

### Example 17

Example 17 was polymer similar to Example 4 but was polymerized without the HEMA monomer. The concentrations of each monomers are listed in Table 10.

TABLE 10
Monomer concentration for Example 17

| Monomers | Example 17 |
|---|---|
| RfMA (g) | 72.5 |
| EHMA (g) | 0.52 |
| SMA (g) | 25.5 |
| 7-EOMA (g) | 12 |
| DEAM (g) | 2.05 |
| DMAM (g) | 0.94 |

### Examples 18 to 21

Examples 18 to 21 were polymer similar to Example 1 but 7-EOMA was replaced by various poly-ethylene/propylene methacryaltes (4-EOMA, 9-POMA, 3.5-EO/2.5-POMA, and octoxy polyethyeneglycol-propyleneglycol methacrylate, respectively). The concentrations of each monomers are listed in Table 11.

TABLE 11
Monomer concentration for Example 18 to 21

| | Example | | | |
|---|---|---|---|---|
| Monomers | 18 | Example 19 | Example 20 | Example 21 |
| RfMA (g) | 63 | 63 | 63 | 63 |
| EHMA (g) | 0.19 | 0.19 | 0.19 | 0.19 |
| SMA (g) | 21.3 | 21.3 | 21.3 | 21.3 |
| HEMA (g) | 1.78 | 1.78 | 1.78 | 1.78 |
| DEAM (g) | 1.78 | 1.78 | 1.78 | 1.78 |
| DMAM (g) | 1.78 | 1.78 | 1.78 | 1.78 |
| 4-EOMA (g) | 10.3 | — | — | — |
| 9-POMA (g) | — | 10.3 | — | — |
| 3.5-EO/2.5- | — | — | 10.3 | — |
| POMA (g) | | | | |
| Octoxy | — | — | — | 10.3 |
| (poly)ethyene | | | | |
| glycol/ | | | | |
| (poly)propylene | | | | |
| glycol | | | | |
| methacrylate | | | | |
| (g) | | | | |

Examples 1 to 7 and 9 to 21 were diluted in European mineral spirits (2% solids) applied to Saltillo and tested according to Test Methods 1 for stain resistance. Stain results for Saltillo are found in Table 12.

### Stain Rating Results

TABLE 12
Stain rating results on saltillo substrates

| | | | | | | | | | Sun | | |
|---|---|---|---|---|---|---|---|---|---|---|---|
| | Red | | | | Blue | | | | tan | Olive | |
| Example | Wine | Coffee | Mustard | Ketchup | Ink | Mayo | MO | Coke | lotion | Oil | Sum |
| 1 | 0 | 2 | 1 | 0 | 2 | 1 | 2 | 0 | 3 | 1 | 12 |
| 2 | 1 | 1 | 0 | 0 | 2 | 1 | 2 | 0 | 2 | 1 | 10 |
| 3 | 4 | 3 | 3 | 1 | 3 | 3 | 4 | 1 | 4 | 4 | 30 |
| 4 | 1 | 1 | 2 | 0 | 1 | 1 | 1 | 1 | 3 | 1 | 12 |
| 5 | 1 | 1 | 1 | 0 | 1 | 1 | 1 | 1 | 2 | 1 | 10 |
| 6 | 1 | 1 | 2 | 0 | 1 | 1 | 1 | 1 | 3 | 1 | 12 |
| 7 | 1 | 1 | 1 | 0 | 1 | 1 | 1 | 1 | 2 | 1 | 10 |
| 9 | 1 | 1 | 3 | 0 | 3 | 2 | 2 | 0 | 4 | 1 | 17 |
| 10 | 2 | 1 | 1 | 0 | 3 | 0 | 1 | 0 | 4 | 1 | 13 |
| 11 | 2 | 2 | 4 | 2 | 1 | 3 | 4 | 0 | 4 | 3 | 25 |
| 12 | 1 | 1 | 3 | 0 | 2 | 1 | 4 | 0 | 4 | 3 | 19 |
| 13 | 3 | 2 | 3 | 0 | 4 | 3 | 3 | 1 | 3 | 2 | 24 |
| 14 | 0 | 2 | 2 | 0 | 3 | 2 | 2 | 0 | 4 | 2 | 17 |
| 15 | 1 | 2 | 2 | 0 | 3 | 1 | 2 | 2 | 3 | *** | 16 |
| 16 | 1 | 1 | 2 | 0 | 2 | 2 | 1 | 0 | 4 | 1 | 14 |
| 17 | 3 | 1 | 1 | 0 | 2 | 0 | 2 | 0 | 4 | 1 | 14 |
| 18 | 1 | 1 | 1 | 0 | 1 | 0 | 1 | 1 | 3 | 0 | 9 |
| 19 | 1 | 1 | 2 | 0 | 4 | 0 | 0 | 1 | 3 | 0 | 12 |
| 20 | 1 | 1 | 1 | 1 | 4 | 0 | 0 | 1 | 3 | 0 | 11 |
| 21 | 1 | 1 | 1 | 1 | 4 | 1 | 0 | 1 | 3 | 1 | 14 |
| 22 | 1 | 1 | 1 | 1 | 3 | 1 | 1 | 1 | 1 | 1 | 12 |
| 23 | 1 | 1 | 1 | 0 | 4 | 0 | 0 | 1 | 2 | 0 | 10 |
| 24 | 2 | 0 | 1 | 0 | 1 | 0 | 0 | 0 | 4 | 0 | 8 |
| A (untreated) | 4 | 4 | 4 | 4 | 4 | 4 | 4 | 4 | 4 | 4 | 40 |

As shown in Table 12, Examples 1 to 7 and 9 to 24 show improved stain resistance for the various stains tested for saltillo compared to the comparative example which is untreated Saltillo.

Examples 2 to 7, 18 to 22, and 24 were diluted in European mineral spirits (2% solids) and applied to marble and tested according to Test Methods 1 for stain resistance. Stain results for Saltillo are found in Table 13.

TABLE 13
Stain rating results on marble substrates

| | | | | | | | | | Sun | | |
|---|---|---|---|---|---|---|---|---|---|---|---|
| | Red | | | | Blue | | | | tan | Olive | |
| Example | Wine | Coffee | Mustard | Ketchup | Ink | Mayo | MO | Coke | lotion | Oil | Sum |
| 2 | 2 | 2 | 0 | 0 | 2 | 1 | 0 | 1 | 1 | 1 | 10 |
| 3 | 2 | 1 | 0 | 0 | 3 | 1 | 1 | 1 | 2 | 1 | 12 |
| 4 | 1 | 2 | 0 | 0 | 3 | 1 | 1 | 2 | 2 | 0 | 12 |
| 5 | 2 | 2 | 1 | 0 | 3 | 1 | 0 | 2 | 3 | 0 | 14 |
| 6 | 1 | 2 | 0 | 0 | 3 | 1 | 0 | 2 | 2 | 0 | 11 |
| 7 | 2 | 2 | 1 | 0 | 3 | 1 | 0 | 2 | 2 | 0 | 13 |
| 18 | 1 | 1 | 0 | 0 | 1 | 0 | 0 | 0 | 0 | 0 | 3 |
| 19 | 1 | 1 | 0 | 0 | 1 | 0 | 0 | 0 | 0 | 0 | 3 |
| 20 | 1 | 1 | 0 | 0 | 1 | 0 | 0 | 0 | 0 | 0 | 3 |
| 21 | 1 | 1 | 0 | 0 | 2 | 0 | 0 | 0 | 0 | 0 | 4 |
| 22 | 1 | 1 | 0 | 0 | 2 | 0 | 0 | 0 | 0 | 0 | 4 |
| 24 | 1 | 2 | 1 | 1 | 2 | 1 | 1 | 1 | 1 | 0 | 11 |
| A | 4 | 4 | 4 | 4 | 4 | 4 | 4 | 4 | 4 | 4 | 40 |
| (untreated) | | | | | | | | | | | |

As shown in Table 13, Examples 2 to 7, 18 to 22, and 24 show improved stain resistance for the various stains tested for marble substrates compared to the comparative example which is untreated marble.

Examples 2 to 7 and 18 to 24 were diluted in European mineral spirits (2% solids) and applied to limestone and tested according to Test Methods 1 for stain resistance. Stain results for Saltillo are found in Table 14.

TABLE 14
Stain rating results on limestone substrates

| | | | | | | | | | Sun | | |
|---|---|---|---|---|---|---|---|---|---|---|---|
| | Red | | | | Blue | | | | tan | Olive | |
| Example | Wine | Coffee | Mustard | Ketchup | Ink | Mayo | MO | Coke | lotion | Oil | Sum |
| 2 | 3 | 3 | 2 | 1 | 4 | 2 | 0 | 2 | 2 | 0 | 19 |
| 3 | 3 | 1 | 1 | 0 | 4 | 1 | 0 | 0 | 1 | 0 | 11 |
| 4 | 1 | 0 | 0 | 0 | 2 | 0 | 0 | 0 | 3 | 0 | 6 |
| 5 | 2 | 0 | 0 | 0 | 2 | 0 | 0 | 1 | 2 | 0 | 7 |
| 6 | 1 | 0 | 0 | 0 | 2 | 0 | 0 | 0 | 3 | 0 | 6 |
| 7 | 1 | 0 | 0 | 0 | 3 | 0 | 0 | 1 | 2 | 0 | 7 |
| 18 | 2 | 1 | 0 | 0 | 2 | 1 | 0 | 1 | 2 | 0 | 9 |
| 19 | 1 | 1 | 0 | 0 | 2 | 0 | 0 | 1 | 2 | 0 | 7 |
| 20 | 2 | 1 | 0 | 0 | 2 | 1 | 0 | 1 | 1 | 0 | 8 |
| 21 | 1 | 1 | 0 | 0 | 2 | 1 | 0 | 1 | 1 | 0 | 7 |
| 22 | 1 | 1 | 0 | 0 | 2 | 0 | 0 | 1 | 2 | 0 | 7 |
| 23 | 1 | 1 | 0 | 0 | 2 | 1 | 0 | 1 | 2 | 0 | 8 |
| 24 | 1 | 0 | 0 | 0 | 2 | 0 | 0 | 0 | 2 | 0 | 5 |

As shown in Table 14, Examples 2 to 7 and 18 to 24 exhibit improved stain resistance for the various stains tested for limestone substrates compared to the comparative example which is untreated limestone.

Examples 1, 4 to 7, and 9 to 24 were diluted in European mineral spirits (2% solids) and applied to Saltillo and tested according to Test Method 2 for water and oil beading and Test Method 3 for water and oil kit repellency are found in Table 15.

TABLE 15
Water and oil beading results on Saltillo substrates

| | |
|---|---|
| Beading | Kit |

| Example | Water | Oil | Water | Oil |
|---|---|---|---|---|
| 1 | 5 | 4 | 11 | 6 |
| 4 | 5 | 5 | 9 | 6 |
| 5 | 5 | 5 | 9 | 6 |
| 6 | 5 | 5 | 9 | 6 |
| 7 | 5 | 5 | 9 | 6 |
| 9 | 5 | 5 | 11 | 6 |
| 10 | 5 | 4 | 11 | 6 |
| 11 | 4 | 5 | 8 | 2 |
| 12 | 5 | 5 | 9 | 4 |
| 13 | 5 | 4 | 6 | 3 |
| 14 | 4 | 5 | 7 | 6 |
| 15 | 5 | 4 | 11 | 6 |
| 16 | 5 | 5 | 10 | 4 |
| 17 | 5 | 4 | 12 | 6 |
| 18 | 5 | 5 | 7 | 6 |
| 19 | 5 | 5 | 6 | 5 |
| 20 | 5 | 5 | 6 | 6 |
| 21 | 5 | 5 | 6 | 5 |
| 22 | 5 | 5 | 6 | 4 |
| 23 | 5 | 5 | 6 | 6 |
| 24 | 5 | 5 | 9 | 6 |
| A | 4 | 5 | 10 | 6 |

As shown in Table 15, Examples 1, 4 to 7, and 9 to 24 exhibit improved water and oil beading as well as water and oil kit repellency for Saltillo substrates compared to the comparative example which is untreated Saltillo.

Examples 4 to 7 were diluted in European mineral spirits (2% solids) and applied to marble and tested according to Test Method 2 for water and oil beading and Test Method 3 for water and oil kit repellency are found in Table 16.

TABLE 16
Water and oil beading results on marble substrates

Beading

| Example | Water | Oil |
|---|---|---|
| 4 | 3 | 3 |
| 5 | 4 | 3 |
| 6 | 4 | 3 |
| 7 | 4 | 4 |

As shown in Table 16, Examples 4 to 7 have improved water and oil beading as well as water and oil kit repellency for marble substrates compared to the comparative example which is untreated marble.

Examples 4 to 7 were diluted in European mineral spirits (2% solids) and applied to limestone and tested according to Test Method 2 for water and oil beading and Test Method 3 for water and oil kit repellency are found in Table 17.

TABLE 17
Water and oil beading results on limestone substrates

Beading

| Example | Water | Oil |
|---|---|---|
| 4 | 5 | 4 |
| 5 | 5 | 4 |
| 6 | 5 | 4 |
| 7 | 5 | 4 |

As shown in Table 17, Examples 4 to 7 have improved water and oil beading as well as water and oil kit repellency for limestone substrates compared to the comparative example which is untreated limestone.

Examples 4 to 7 were applied to leather and tested according to Test Method 3 for water and oil kit repellency. Results are found in Table 18.

TABLE 18
Water and oil repellency for leather

Kit

| Example | Kit Water | Kit Oil |
|---|---|---|
| 4 | 8 | 5 |
| 6 | 7 | 4 |

As shown in Table 18, Examples 4 to 7 have improved water and oil kit repellency for compared to the comparative example which is untreated leather.

What is claimed is:

1. A partially fluorinated copolymer comprising the reaction product of monomers copolymerized in the following percentages by weight:
a) from about 45% to about 75% of one or more monomers of Formula (I):
R_{f}-L-Q-C(O)—CR¹═CH₂ (I);
b) from about 25% to about 30% of one or more monomers of Formula (II):
R_{H}-Q-C(O)—CR²═CH₂ (II);
c) from about 0.5% to about 15% of one or more monomers of Formula (III):
R—(OCH₂CH₂)ₙ—(OCH₂CH(CH₃))ₚQ-C(O)—CR³═CH₂ (III);
d) from about 0.1% to about 4% of one or more monomers of Formula (IV): 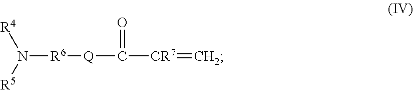
e) from about 0% to about 2% of one or more monomers of Formula (V):
HO—C(O)—CR⁸═CH2 (V);
f) from about from about 0% to about 2% of one or more monomers of Formula (VI):
HO—CH₂CH₂-Q-C(O)—CR⁹═CH₂ (VI);
g) from about from about 0% to about 2% of one or more monomers of Formula (VII):
CH₂═CR¹⁰C(O)O(CH₂CH₂O)ₓ(CH2CH(CH3)O)_{y}C(O)CR¹¹═CH₂ (VII);
wherein
R_{f} is a linear or branch fluoroalkyl of 2 to 10 carbons optionally interrupted by 1 to 4 interrupting groups —O—, —CH₂—, and/or —CHF— groups;
R_{H} is a linear, branched, or cyclic alkyl chain of 7 to 22 carbons;
each Q is independently —O— or —S—;
L is —R¹²—, —SO₂—N(R¹³)—R¹⁵—, —CO—N(R¹⁴)—R¹⁵—, —CH₂CH(OR¹⁴)CH₂—, —R⁶—SO₂—N(R¹⁴)—R¹⁵—, or —R¹⁵—O—C(O)—N(R¹⁴)—R¹⁵—;
R¹, R³, R⁷, R⁸, R⁹, R¹⁰, R¹¹ are each independently H or —CH₃;
R is —H or a linear, branched, or cyclic alkyl chain of 1 to 20 carbons;
R² is —CH₃;
R⁴ and R⁵ are each independently methyl or ethyl;
R⁶, R¹² and R¹⁵ are each independently a linear or branched divalent alkyl chain of 2 to 10 carbons;
R¹³ and R¹⁴ are each independently —H, —CH₃, C₂ to C₁₀ alkylene, or C₁ to C₄ acyl;
n is 0 to 10 and p is 0 to 10 provided that when p is 0, n is at least 2
and n+p is greater than 0; and
x is 0 to 10 and y is 0 to 10 provided that x+y is at least 1;
wherein the concentration of monomers of a), b), c), d), e), f), and g) is equal to 100% by weight.

2. The partially fluorinated copolymer of claim 1 wherein R_{f} is a fluoroalkyl of 2 to 6 carbons, L is R¹², R¹ is H or CH₃.

3. The partially fluorinated copolymer of claim 2, wherein R_{f} is a fluoroalkyl of 4 to 6 carbons, and R¹ is CH₃.

4. The partially fluorinated copolymer of claim 1 wherein R_{H} is linear or branched alkyl chain of 7 to 22 carbons and Q is O.

5. The partially fluorinated copolymer of claim 4 wherein R_{H} is an octyl, 2-ethylhexyl, decyl, isodecyl, lauryl, cetyl, or stearyl.

6. The partially fluorinated copolymer of claim 1 wherein p is 0.

7. The partially fluorinated copolymer of claim 1 wherein p and n are both greater than 0.

8. The partially fluorinated copolymer of claim 1 wherein the repeat unit of monomer e) is present.

9. The partially fluorinated copolymer of claim 1 wherein the repeat unit of monomers e) and f) are present.

10. The partially fluorinated copolymer of claim 1 wherein the repeat unit of monomers e), f), and g) are present.

11. The partially fluorinated copolymer of claim 1 wherein the repeat unit of monomer f) is present.

12. The partially fluorinated copolymer of claim 1 wherein the repeat unit of monomers f) and g) are present.

13. The partially fluorinated copolymer of claim 1 wherein the repeat unit of monomers g) is present.

14. The partially fluorinated copolymer of claim 1 wherein the repeat unit of monomers e) and g) are present.

15. A method for treating a hard surface substrate comprises contacting the hard surface substrate with a partially fluorinated copolymer comprising the reaction product of monomers copolymerized in the following percentages by weight:
a) from about 45% to about 75% of one or more monomers of Formula (I):
R_{f}-L-Q-C(O)—CR¹═CH₂ (I);
b) from about 25% to about 30% of one or more monomers of Formula (II):
R_{H}-Q-C(O)—CR²═CH₂ (II);
c) from about 0.5% to about 15% of one or more monomers of Formula (III):
R—(OCH₂CH₂)ₙ—(OCH₂CH(CH₃))ₚQ-C(O)—CR³═CH₂ (III);
d) from about 0.1% to about 4% of one or more monomers of Formula (IV): 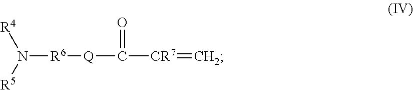
e) from about 0% to about 2% of one or more monomers of Formula (V):
HO—C(O)—CR⁸═CH₂ (V);
f) from about from about 0% to about 2% of one or more monomers of Formula (VI):
HO—CH₂CH₂-Q-C(O)—CR⁹═CH₂ (VI);
g) from about from about 0% to about 2% of one or more monomers of Formula (VII):
CH₂═CR¹⁰C(O)O(CH₂CH₂O)ₓ(CH2CH(CH3)O)_{y}C(O)CR¹¹═CH₂ (VII);
wherein
R_{f} is a linear or branch fluoroalkyl of 2 to 10 carbons optionally interrupted by 1 to 4 interrupting groups —O—, —CH₂—, and/or —CHF— groups;
R_{H} is a linear, branched, or cyclic alkyl chain of 7 to 22 carbons;
each Q is independently —O— or —S—;
L is —R¹²—, —SO₂—N(R¹³)—R¹⁵—, —CO—N(R¹⁴)—R¹⁵—, —CH₂CH(OR¹⁴)CH₂—, —R⁶—SO₂—N(R¹⁴)—R¹⁵—, or —R¹⁵—O—C(O)—N(R¹⁴)—R¹⁵—;
R¹, R³, R⁷, R⁸, R⁹, R¹⁰, R¹¹ are each independently H or —CH₃;
R is —H or a linear, branched, or cyclic alkyl chain of 1 to 20 carbons;
R² is —CH₃;
R⁴ and R⁵ are each independently methyl or ethyl;
R⁶, R¹² and R¹⁵ are each independently a linear or branched divalent alkyl chain of 2 to 10 carbons;
R¹³ and R¹⁴ are each independently —H, —CH₃, C₂ to C₁₀ alkylene, or C₁ to C₄ acyl;
n is 0 to 10 and p is 0 to 10 provided that when p is 0, n is at least 2
and n+p is greater than 0; and
x is 0 to 10 and y is 0 to 10 provided that x+y is at least 1;
wherein the concentration of monomers of a), b), c), d), e), f), and g) is equal to 100% by weight.

16. The method of claim 15 wherein the contacting is by brush, spray, roller, doctor blade, wipe and dip techniques.

17. The method of claim 15 wherein the hard surface substrate is unglazed concrete, brick, tile, stone, granite, limestone, grout, mortar, composite materials, terrazzo, gypsum board, marble, statuary, monuments, or wood.

18. A substrate treated with the method of claim 16 which is unglazed concrete, brick, tile, stone, granite, limestone, grout, mortar, composite materials, terrazzo, gypsum board, marble, statuary, monuments, or wood.

19. A method for treating leather substrates comprises contacting the leather substrate with a partially fluorinated copolymer comprising the reaction product of monomers copolymerized in the following percentages by weight:
a) from about 45% to about 75% of one or more monomers of Formula (I):
R_{f}-L-Q-C(O)—CR¹═CH₂ (I);
b) from about 25% to about 30% of one or more monomers of Formula (II):
R_{H}-Q-C(O)—CR²═CH₂ (II);
c) from about 0.5% to about 15% of one or more monomers of Formula (III):
R—(OCH₂CH₂)ₙ—(OCH₂CH(CH₃))ₚQ-C(O)—CR³═CH₂ (III);
d) from about 0.1% to about 4% of one or more monomers of Formula (IV): 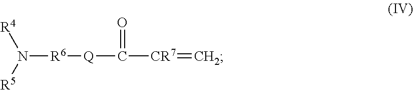
e) from about 0% to about 2% of one or more monomers of Formula (V):
HO—C(O)—CR⁸═CH2 (V);
f) from about from about 0% to about 2% of one or more monomers of Formula (VI):
HO—CH₂CH₂-Q-C(O)—CR⁹═CH₂ (VI);
g) from about from about 0% to about 2% of one or more monomers of Formula (VII):
CH₂═CR¹⁰C(O)O(CH₂CH₂O)ₓ(CH2CH(CH3)O)_{y}C(O)CR¹¹═CH₂ (VII);
wherein
R_{f} is a linear or branch fluoroalkyl of 2 to 10 carbons optionally interrupted by 1 to 4 interrupting groups —O—, —CH₂—, and/or —CHF— groups;
R_{H} is a linear, branched, or cyclic alkyl chain of 7 to 22 carbons;
each Q is independently —O— or —S—;
L is —R¹²—, —SO₂—N(R¹³)—R¹⁵—, —CO—N(R¹⁴)—R¹⁵—, —CH₂CH(OR¹⁴)CH₂—, —R⁶—SO₂—N(R¹⁴)—R¹⁵—, or —R¹⁵—O—C(O)—N(R¹⁴)—R¹⁵—;
R¹, R³, R⁷, R⁸, R⁹, R¹⁰, R¹¹ are each independently H or —CH₃;
R is —H or a linear, branched, or cyclic alkyl chain of 1 to 20 carbons;
R² is —CH₃;
R⁴ and R⁵ are each independently methyl or ethyl;
R⁶, R¹² and R¹⁵ are each independently a linear or branched divalent alkyl chain of 2 to 10 carbons;
R¹³ and R¹⁴ are each independently —H, —CH₃, C₂ to C₁₀ alkylene, or C₁ to C₄ acyl;
n is 0 to 10 and p is 0 to 10 provided that when p is 0, n is at least 2
and n+p is greater than 0; and
x is 0 to 10 and y is 0 to 10 provided that x+y is at least 1;
wherein the concentration of monomers of a), b), c), d), e), f), and g) is equal to 100% by weight.

20. The method of claim 19 wherein the contacting is by spray, dipping, foam, nip, immersion, brush, roller, sponge, mat techniques.
